(19) United States
(12) Patent Application Publication
(10) Pub. No.: US 2022/0231873 A1
(43) Pub. Date: Jul. 21, 2022

(54) SYSTEM FOR FACILITATING COMPREHENSIVE MULTILINGUAL VIRTUAL OR REAL-TIME MEETING WITH REAL-TIME TRANSLATION

(71) Applicant: Ogoul Technology Co., W.L.L., Doha (QA)

(72) Inventors: SALAH M. WERFELLI, MORGAN HILL, CA (US); KHALED JASSIM J S AL-JABER, DOHA (QA); TANWIR ZAFAR SYEDMOHAMMAD, TRACY, CA (US)

(21) Appl. No.: 17/578,710

(22) Filed: Jan. 19, 2022

Related U.S. Application Data
(60) Provisional application No. 63/139,089, filed on Jan. 19, 2021.

(51) Int. Cl. H04L 12/18; H04L 65/1083; G10L 15/26; G10L 13/00; G06F 40/58

(52) U.S. Cl. CPC H04L 12/1831; H04L 65/1083; G06F 40/58; G10L 13/00; G10L 15/26

(57) ABSTRACT

The present invention relates to a system for facilitating a comprehensive virtual or real-time meeting with accurate real-time translation. The present invention particularly relates to the afore-mentioned system wherein the aforesaid system may be utilised by direct room meetings or virtual meetings. The aforesaid system while facilitating communication with translation will have the capability of recording the whole event. In addition, the aforesaid system may further allows securing and saving the transcripts of whole meeting in text file and also secure the recorded conversation.

### CROSS REFERENCES OF RELATED PATENT OR PATENT APPLICATIONS

The present application claims the priorities from U.S. Provisional Patent Application No. 63/139,089 filed Jan. 19, 2021, 63/113,058 filed Nov. 12, 2020, 63/054,355 filed on Jul. 21, 2020, 63/054,389 filed on Jul. 21, 2020, related, the temporary patent application case is incorporated herein by reference.

### COPYRIGHT RESERVATION

A portion of the disclosure of this patent document and appendices contain material that is subject to copyright protection. The copyright owner has no objection to the facsimile reproduction by anyone of this patent document or the patent disclosure, as it appears in the U.S. Patent and Trademark Office patent file or records, but otherwise reserves all copyright rights whatsoever.

### FIELD OF THE INVENTION

The present invention relates to a system for facilitating a comprehensive virtual or real-time meeting with accurate real-time translation. The present invention particularly relates to the afore-mentioned system wherein the aforesaid system may be utilised by direct room meetings or virtual meetings. The aforesaid system while facilitating communication with translation will have the capability of recording the whole event. In addition, the aforesaid system may further allows securing and saving the transcripts of whole meeting in text file and also secure the recorded conversation.

### BACKGROUND OF THE INVENTION

Human abilities such as hearing, vision, memory, foreign or native language comprehension, and the like may be limited for various reasons. For example, with aging, various abilities such as hearing, vision, memory, may decline or otherwise become compromised. As the population in general ages, such declines may become more common and widespread. In addition, young people are increasingly listening to music through headphones, which may also result in hearing loss at earlier ages.

In addition, limits on human abilities may be exposed by factors other than aging, injury, or overuse. As one example, the world population is faced with an ever increasing amount of information to review, remember, and/or integrate. Managing increasing amounts of information becomes increasingly difficult in the face of limited or declining abilities such as hearing, vision, and memory. As another example, as the world becomes increasingly virtually and physically connected (e.g., due to improved communication and cheaper travel), people are more frequently encountering others who speak different languages. In addition, the communication technologies that support an interconnected, global economy may further expose limited human abilities. For example, it may be difficult for a user to determine who is speaking during a conference call. Even if the user is able to identify the speaker, it may still be difficult for the user to recall or access related information about the speaker and/or topics discussed during the call. Also, it may be difficult for a user to recall all of the events or information discussed during the course of a conference call or other type of conversation.

Current approaches to addressing limits on human abilities may suffer from various drawbacks. For example, there may be a social stigma connected with wearing hearing aids, corrective lenses, or similar devices. In addition, hearing aids typically perform only limited functions, such as amplifying or modulating sounds for a hearer. As another example, current approaches to foreign language translation, such as phrase books or time-intensive language acquisition, are typically inefficient and/or unwieldy. Furthermore, existing communication technologies are not well integrated with one another, making it difficult to access information via a first device that is relevant to a conversation occurring via a second device. Also, manual note taking during the course of a conference call or other conversation may be intrusive, distracting, and/or ineffective. For example, a note-taker may not be able to accurately capture everything that was said and/or meeting notes may not be well integrated with other information sources or items that are related to the subject matter of the conference call.

### BRIEF DESCRIPTION OF THE DRAWING(S)

FIG. 1A is an example block diagram of an ability enhancement facilitator system according to an example embodiment.

FIG. 1B is an example block diagram illustrating various conferencing devices according to example embodiments.

FIG. 2 is an example functional block diagram of the aforementioned system according to an example embodiment.

### DETAILED DESCRIPTION OF THE INVENTION

The present invention may be understood more readily by reference to the following detailed description of the invention taken in connection with the accompanying drawing figures, which forms a part of this disclosure. It is to be understood that this invention is not limited to the specific devices, methods, conditions or parameters described and/or shown herein and that the terminology used herein is for the example only and is not intended to be limiting of the claimed invention. Also, as used in the specification including the appended claims, the singular forms ‘a’, ‘an’, and ‘the’ include the plural, and references to a particular numerical value includes at least that particular value unless the content clearly directs otherwise. Ranges may be expressed herein as from ‘about’ or ‘approximately’ another particular value when such a range is expressed another embodiment. Also, it will be understood that unless otherwise indicated, dimensions and material characteristics stated herein are by way of example rather than limitation, and are for better understanding of sample embodiment of suitable utility, and variations outside of the stated values may also be within the scope of the invention depending upon the particular application.

Embodiments will now be described in detail with reference to the accompanying drawings. To avoid unnecessarily obscuring the present disclosure, well-known features may not be described or substantially the same elements may not be redundantly described, for example. This is for ease of understanding.

The following description are provided to enable those skilled in the art to fully understand the present disclosure and are in no way intended to limit the scope of the present disclosure as set forth.

In one embodiment of the present invention, a system for facilitating a comprehensive virtual or real-time meeting with accurate real-time translation is disclosed herein.

Embodiments described herein provide enhanced computer- and network-based methods and systems for enhanced voice conferencing and, more particularly, for recording and presenting voice conference history information based on speaker-related information determined from speaker utterances and/or other sources. Example embodiments provide an a system for facilitating a comprehensive virtual or real-time meeting with accurate real-time translation (“system”). The system may augment, enhance, or improve the senses (e.g., hearing), faculties (e.g., memory, language comprehension), and/or other abilities of a user, such as by recording and presenting voice conference history based on speaker-related information related to participants in a voice conference (e.g., conference call, face-to-face meeting). For example, when multiple speakers engage in a voice conference (e.g., a telephone conference), the system may “listen” to the voice conference in order to determine speaker-related information, such as identifying information (e.g., name, title) about the current speaker (or some other speaker) and/or events/communications relating to the current speaker and/or to the subject matter of the conference call generally. Then, the system may record voice conference history information based on the determined speaker-related information. The recorded conference history information may include transcriptions of utterances made by users, indications of topics discussed during the voice conference, information items (e.g., email messages, calendar events, documents) related to the voice conference, or the like. Next, the system may inform a user (typically one of the participants in the voice conference) of the recorded conference history information, such as by presenting the information via a conferencing device (e.g., smart phone, laptop, desktop telephone) associated with the user. The user can then receive the information (e.g., by reading or hearing it via the conferencing device) provided by the system and advantageously use that information to avoid embarrassment (e.g., due to having joined the voice conference late and thus having missed some of its contents), engage in a more productive conversation (e.g., by quickly accessing information about events, deadlines, or communications discussed during the voice conference), or the like.

In some embodiments, the system is configured to receive data that represents speech signals from a voice conference amongst multiple speakers. The multiple speakers may be remotely located from one another, such as by being in different rooms within a building, by being in different buildings within a site or campus, by being in different cities, or the like. Typically, the multiple speakers are each using a conferencing device, such as a land-line telephone, cell phone, smart phone, computer, or the like, to communicate with one another. In some cases, such as when the multiple speakers are together in one room, the speakers may not be using a conferencing device to communicate with one another, but at least one of the speakers may have a conferencing device (e.g., a smart phone or personal media player/device that records conference history information as described.

The system may obtain the data that represents the speech signals from one or more of the conferencing devices and/or from some intermediary point, such as a conference call facility, chat system, videoconferencing system, PBX, or the like. The system may then determine voice conference-related information, including speaker-related information associated with the one or more of the speakers. Determining speaker-related information may include identifying the speaker based at least in part on the received data, such as by performing speaker recognition and/or speech recognition with the received data. Determining speaker-related information may also or instead include determining an identifier (e.g., name or title) of the speaker, content of the speaker's utterance, an information item (e.g., a document, event, communication) that references the speaker, or the like. Next, the system records conference history information based on the determined speaker-related information. In some embodiments, recording conference history information may include generating a timeline, log, history, or other structure that associates speaker-related information with a timestamp or other time indicator. Then, the system may inform a user of the conference history information by, for example, visually presenting the conference history information via a display screen of a conferencing device associated with the user. In other embodiments, some other display may be used, such as a screen on a laptop computer that is being used by the user while the user is engaged in the voice conference via a telephone. In some embodiments, the system may inform the user in an audible manner, such as by “speaking” the conference-history information via an audio speaker of the conferencing device.

In some embodiments, the system may perform other services, including translating utterances made by speakers in a voice conference, so that a multi-lingual voice conference may be facilitated even when some speakers do not understand the language used by other speakers. In such cases, the determined speaker-related information may be used to enhance or augment language translation and/or related processes, including speech recognition, natural language processing, and the like. In addition, the conference history information may be recorded in one or more languages, so that it can be presented in a native language of each of one or more users.

In one embodiment of the present invention, user can speak in a mic, which is connected to a central server. Further, user will listen to conversation in a headphone or speaker wherein audio will be converted to text. The aforesaid system may translate the text into users' choice of language. Translated text will be displayed on every users' monitor in the language of their choice. Users can listen to the text displayed on their terminal. Host of the meeting will be able to save the transcript of the whole meeting. Host will be able to save the audio conversation of the file.

Infrastructure Setup
Central server over the cloud computing infrastructure
Meeting Software hosted on cloud in the central server
Translation engine hooked up to the meeting software
Speech to Text and Text to Speech conversion Engine

Software Contains Following Flow:
Host sets up the meeting
Sends meeting invitations to all participants
Participants can join the meeting in a meeting room set up or remotely by logging in to the system with their unique ID
Each user will set up their native language
Each participant will have his or her monitor (laptop, tablets etc.), mic and headphone or ear piece
Participants of the meeting will speak in their assigned mic
Participants will listen in their assigned headphone.
When someone speaks in the mic software will capture the speech
Speech then will be converted to text
Converted text will then be translated for all participants in their native language
All participants will see the translated text on their individual screen
Participants will have option to see the original text
Translated text then will converted to speech in user's native language
Every user will be able to hear the translated text in their earphone
Option will be available to turn off the speaker or earphone
Next to each translated text a speaker icon will be shown
Participants can press the speaker icon to listed to the speech
Participants can identify their desire to speak by using the raise hand feature
A participant can leave the meeting in the middle and rejoin the meeting if meeting has not been finished
Participants can also turn on video
Participants can give a presentation for all participants

A System for Facilitating a Comprehensive Virtual or Real-Time Meeting with Accurate Real-Time Translation Overview

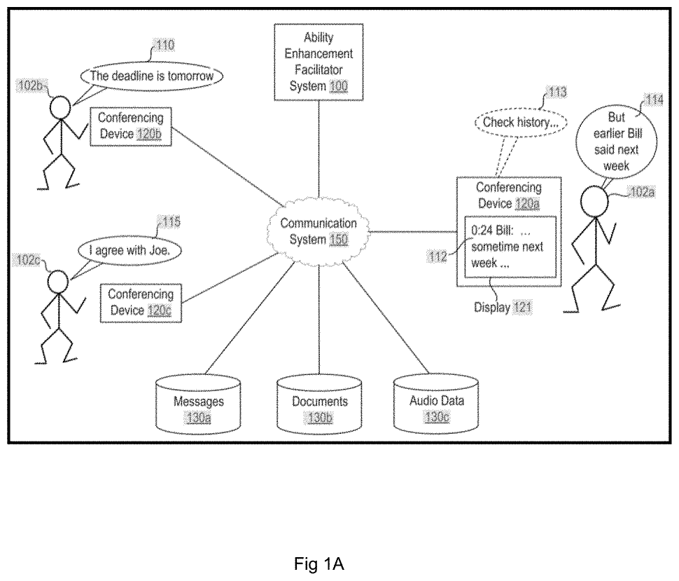

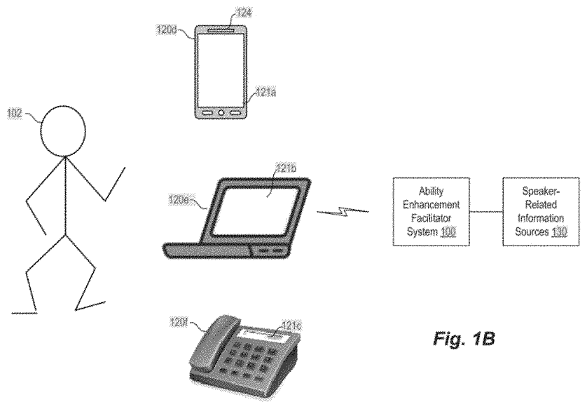

FIG. 1A is an example block diagram of an ability enhancement facilitator system according to an example embodiment. In particular, FIG. 1A shows multiple speakers 102 a-102 c (collectively also referred to as “participants”) engaging in a voice conference with one another. In particular, a first speaker 102 a (who may also be referred to as a “user” or a “participant”) is engaging in a voice conference with speakers 102 b and 102c. Abilities of the speaker 102a are being enhanced, via a conferencing device 120a, by an Ability Enhancement Facilitator System (“system”) 100. The conferencing device 120a includes a display 121 that is configured to present text and/or graphics. The conferencing device 120a also includes an audio speaker (not shown) that is configured to present audio output. Speakers 102b and 102c are each respectively using a conferencing device 120b and 120c to engage in the voice conference with each other and speaker 102a via a communication system 150.

The system 100 and the conferencing devices 120 are communicatively coupled to one another via the communication system 150. The system 100 is also communicatively coupled to speaker-related information sources 130, including messages 130a, documents 130b, and audio data 130c. The system 100 uses the information in the information sources 130, in conjunction with data received from the conferencing devices 120, to determine information related to the voice conference, including speaker-related information associated with the speakers 102.

In the scenario illustrated in FIG. 1A, the voice conference among the participants 102 is under way. For this example, the participants 102 in the voice conference are attempting to determine the date of a particular deadline for a project. The speaker 102b asserts that the deadline is tomorrow, and has made an utterance 110 by speaking the words “The deadline is tomorrow.” However, this assertion is counter to a statement that the speaker 102b made earlier in the voice conference. The speaker 102a may have a notion or belief that the speaker 102b is contradicting himself, but may not be able to support such an assertion without additional evidence or information. Alternatively, the speaker 102a may have joined the voice conference once it was already in progress, and thus have missed the portion of the voice conference when the deadline was initially discussed. As will be discussed further below, the system 100 will inform the speaker 102a of the relevant voice conference history information, such that the speaker 102a can request that the speaker 102b be held to his earlier statement setting the deadline next week rather than tomorrow.

The system 100 receives data representing a speech signal that represents the utterance 110, such as by receiving a digital representation of an audio signal transmitted by conferencing device 120b. The data representing the speech signal may include audio samples (e.g., raw audio data), compressed audio data, speech vectors (e.g., mel frequency cepstral coefficients), and/or any other data that may be used to represent an audio signal. The system 100 may receive the data in various ways, including from one or more of the conferencing devices or from some intermediate system (e.g., a voice conferencing system that is facilitating the conference between the conferencing devices 120).

The system 100 then determines speaker-related information associated with the speaker 102b. Determining speaker-related information may include identifying the speaker 102b based on the received data representing the speech signal. In some embodiments, identifying the speaker may include performing speaker recognition, such as by generating a “voice print” from the received data and comparing the generated voice print to previously obtained voice prints. For example, the generated voice print may be compared to multiple voice prints that are stored as audio data 130c and that each correspond to a speaker, in order to determine a speaker who has a voice that most closely matches the voice of the speaker 102b. The voice prints stored as audio data 130c may be generated based on various sources of data, including data corresponding to speakers previously identified by the system 100, voice mail messages, speaker enrollment data, or the like.

In some embodiments, identifying the speaker 102b may include performing speech recognition, such as by automatically converting the received data representing the speech signal into text. The text of the speaker's utterance may then be used to identify the speaker 102b. In particular, the text may identify one or more entities such as information items (e.g., communications, documents), events (e.g., meetings, deadlines), persons, or the like, that may be used by the system 100 to identify the speaker 102b. The information items may be accessed with reference to the messages 130a and/or documents 130b. As one example, the speaker's utterance 110 may identify an email message that was sent to the speaker 102b and possibly others (e.g., “That sure was a nasty email Bob sent”). As another example, the speaker's utterance 110 may identify a meeting or other event to which the speaker 102b and possibly others are invited.

Note that in some cases, the text of the speaker's utterance 110 may not definitively identify the speaker 102b, such as because the speaker 102b has not previously met or communicated with other participants in the voice conference or because a communication was sent to recipients in addition to the speaker 102b. In such cases, there may be some ambiguity as to the identity of the speaker 102b. However, in such cases, a preliminary identification of multiple candidate speakers may still be used by the system 100 to narrow the set of potential speakers, and may be combined with (or used to improve) other techniques, including speaker recognition, speech recognition, language translation, or the like. In addition, even if the speaker 102 is unknown to the user 102a the system 100 may still determine useful demographic or other speaker-related information that may be fruitfully employed for speech recognition or other purposes.

Note also that speaker-related information need not definitively identify the speaker. In particular, it may also or instead be or include other information about or related to the speaker, such as demographic information including the gender of the speaker 102, his country or region of origin, the language(s) spoken by the speaker 102, or the like. Speaker-related information may include an organization that includes the speaker (along with possibly other persons, such as a company or firm), an information item that references the speaker (and possibly other persons), an event involving the speaker, or the like. The speaker-related information may generally be determined with reference to the messages 130a, documents 130b, and/or audio data 130c. For example, having determined the identity of the speaker 102, the system 100 may search for emails and/or documents that are stored as messages 130a and/or documents 103b and that reference (e.g., are sent to, are authored by, are named in) the speaker 102.

Other types of speaker-related information is contemplated, including social networking information, such as personal or professional relationship graphs represented by a social networking service, messages or status updates sent within a social network, or the like. Social networking information may also be derived from other sources, including email lists, contact lists, communication patterns (e.g., frequent recipients of emails), or the like.

The system 100 then determines and/or records (e.g., stores, saves) conference history information based on the determined speaker-related information. For example, the system 100 may associate a timestamp with speaker-related information, such a transcription of an utterance (e.g., generated by a speech recognition process), an indication of an information item referenced by a speaker (e.g., a message, a document, a calendar event), topics discussed during the voice conference, or the like. The conference history information may be recorded locally to the system 100, on conferencing devices 120, or other locations, such as cloud-based storage systems.

The system 100 then informs the user (speaker 102a) of at least some of the conference history information. Informing the user may include audibly presenting the information to the user via an audio speaker of the conferencing device 120a. In this example, the conferencing device 120a tells the user 102a, such as by playing audio via an earpiece or in another manner that cannot be detected by the other participants in the voice conference, to check the conference history presented by conferencing device 120a. In particular, the conferencing device 120a plays audio that includes the utterance 113 “Check history” to the user. The system 100 may cause the conferencing device 120a to play such a notification because, for example, it has automatically searched the conference history and determined that the topic of the deadline has been previously discussed during the voice conference.

Informing the user of the conference history information may also or instead include visually presenting the information, such as via the display 121 of the conferencing device 120a. In the illustrated example, the system 100 causes a message 112 that includes a portion of a transcript of the voice conference to be displayed on the display 121. In this example, the displayed transcript includes a statement from Bill (speaker 102b) that sets the project deadline to next week, not tomorrow. Upon reading the message 112 and thereby learning of the previously established project deadline, the speaker 102a responds to the original utterance 110 of speaker 102b (Bill) with a response utterance 114 that includes the words “But earlier Bill said next week,” referring to the earlier statement of speaker 102b that is counter to the deadline expressed by his current utterance 110. In the illustrated example, speaker 102c, upon hearing the utterance 114, responds with an utterance 115 that includes the words “I agree with Joe,” indicating his agreement with speaker 102a.

As the speakers 102a-102c continue to engage in the voice conference, the system 100 may monitor the conversation and continue to record and present conference history information based on speaker-related information at least for the speaker 102a. Another example function that may be performed by the system 100 includes concurrently presenting speaker-related information as it is determined, such as by presenting, as each of the multiple speakers takes a turn speaking during the voice conference, information about the identity of the current speaker. For example, in response to the onset of an utterance of a speaker, the system 100 may display the name of the speaker on the display 121, so that the user is always informed as to who is speaking.

The system 100 may perform other services, including translating utterances made by speakers in the voice conference, so that a multi-lingual voice conference may be conducted even between participants who do not understand all of the languages being spoken. Translating utterances may initially include determining speaker-related information by automatically determining the language that is being used by a current speaker. Determining the language may be based on signal processing techniques that identify signal characteristics unique to particular languages. Determining the language may also or instead be performed by simultaneous or concurrent application of multiple speech recognizers that are each configured to recognize speech in a corresponding language, and then choosing the language corresponding to the recognizer that produces the result having the highest confidence level. Determining the language may also or instead be based on contextual factors, such as GPS information indicating that the current speaker is in Germany, Austria, or some other region where German is commonly spoken.

Having determined speaker-related information, the system 100 may then translate an utterance in a first language into an utterance in a second language. In some embodiments, the system 100 translates an utterance by first performing speech recognition to translate the utterance into a textual representation that includes a sequence of words in the first language. Then, the system 100 may translate the text in the first language into a message in a second language, using machine translation techniques. Speech recognition and/or machine translation may be modified, enhanced, and/or otherwise adapted based on the speaker-related information. For example, a speech recognizer may use speech or language models tailored to the speaker's gender, accent/dialect (e.g., determined based on country/region of origin), social class, or the like. As another example, a lexicon that is specific to the speaker may be used during speech recognition and/or language translation. Such a lexicon may be determined based on prior communications of the speaker, profession of the speaker (e.g., engineer, attorney, doctor), or the like.

Once the system 100 has translated an utterance in a first language into a message in a second language, the system 100 can present the message in the second language. Various techniques are contemplated. In one approach, the system 100 causes the conferencing device 120a (or some other device accessible to the user) to visually display the message on the display 121. In another approach, the system 100 causes the conferencing device 120a (or some other device) to “speak” or “tell” the user/speaker 102a the message in the second language. Presenting a message in this manner may include converting a textual representation of the message into audio via text-to-speech processing (e.g., speech synthesis), and then presenting the audio via an audio speaker (e.g., earphone, earpiece, earbud) of the conferencing device 120a.

At least some of the techniques described above with respect to translation may be applied in the context of generating and recording conference history information. For example, speech recognition and natural language processing may be employed by the system 100 to transcribe user utterances, determine topics of conversation, identify information items referenced by speakers, and the like.

FIG. 1B is an example block diagram illustrating various conferencing devices according to example embodiments. In particular, FIG. 1B illustrates an system 100 in communication with example conferencing devices 120 d-120 f. Conferencing device 120 d is a smart phone that includes a display 121a and an audio speaker 124. Conferencing device 120 e is a laptop computer that includes a display 121b. Conferencing device 120 f is an office telephone that includes a display 121c. Each of the illustrated conferencing devices 120 includes or may be communicatively coupled to a microphone operable to receive a speech signal from a speaker. As described above, the conferencing device 120 may then convert the speech signal into data representing the speech signal, and then forward the data to the system 100.

As an initial matter, note that the system 100 may use output devices of a conferencing device or other devices to present information to a user, such as speaker-related information and/or conference history information that may generally assist the user in engaging in a voice conference with other participants. For example, the system 100 may present speaker-related information about a current or previous speaker, such as his name, title, communications that reference or are related to the speaker, and the like.

For audio output, each of the illustrated conferencing devices 120 may include or be communicatively coupled to an audio speaker operable to generate and output audio signals that may be perceived by the user 102. As discussed above, the system 100 may use such a speaker to provide speaker-related information and/or conference history information to the user 102. The system 100 may also or instead audibly notify, via a speaker of a conferencing device 120, the user 102 to view information displayed on the conferencing device 120. For example, the system 100 may cause a tone (e.g., beep, chime) to be played via the earpiece of the telephone 120 f. Such a tone may then be recognized by the user 102, who will in response attend to information displayed on the display 121c. Such audible notification may be used to identify a display that is being used as a current display, such as when multiple displays are being used. For example, different first and second tones may be used to direct the user's attention to the smart phone display 121a and laptop display 121b, respectively. In some embodiments, audible notification may include playing synthesized speech (e.g., from text-to-speech processing) telling the user 102 to view speaker-related information and/or conference history information on a particular display device (e.g., “See email on your smart phone”).

The system 100 may generally cause information (e.g., speaker-related information, conference history information, translations) to be presented on various destination output devices. In some embodiments, the system 100 may use a display of a conferencing device as a target for displaying information. For example, the system 100 may display information on the display 121a of the smart phone 120 d. On the other hand, when the conferencing device does not have its own display or if the display is not suitable for displaying the determined information, the system 100 may display information on some other destination display that is accessible to the user 102. For example, when the telephone 120 f is the conferencing device and the user also has the laptop computer 120 e in his possession, the system 100 may elect to display an email or other substantial document upon the display 121b of the laptop computer 120 e. Thus, as a general matter, a conferencing device may be any device with which a person may participate in a voice conference, by speaking, listening, seeing, or other interaction modality.

The system 100 may determine a destination output device for conference history information, speaker-related information, translations, or other information. In some embodiments, determining a destination output device may include selecting from one of multiple possible destination displays based on whether a display is capable of displaying all of the information. For example, if the environment is noisy, the system may elect to visually display a transcription or a translation rather than play it through a speaker. As another example, if the user 102 is proximate to a first display that is capable of displaying only text and a second display capable of displaying graphics, the system 100 may select the second display when the presented information includes graphics content (e.g., an image). In some embodiments, determining a destination display may include selecting from one of multiple possible destination displays based on the size of each display. For example, a small LCD display (such as may be found on a mobile phone or telephone 120 f) may be suitable for displaying a message that is just a few characters (e.g., a name or greeting) but not be suitable for displaying longer message or large document. Note that the system 100 may select among multiple potential target output devices even when the conferencing device itself includes its own display and/or speaker.

Determining a destination output device may be based on other or additional factors. In some embodiments, the system 100 may use user preferences that have been inferred (e.g., based on current or prior interactions with the user 102) and/or explicitly provided by the user. For example, the system 100 may determine to present a transcription, translation, an email, or other speaker-related information onto the display 121a of the smart phone 120 d based on the fact that the user 102 is currently interacting with the smart phone 120 d.

Note that although the system 100 is shown as being separate from a conferencing device 120, some or all of the functions of the system 100 may be performed within or by the conferencing device 120 itself. For example, the smart phone conferencing device 120 d and/or the laptop computer conferencing device 120 e may have sufficient processing power to perform all or some functions of the system 100, including one or more of speaker identification, determining speaker-related information, speaker recognition, speech recognition, generating and recording conference history information, language translation, presenting information, or the like. In some embodiments, the conferencing device 120 includes logic to determine where to perform various processing tasks, so as to advantageously distribute processing between available resources, including that of the conferencing device 120, other nearby devices (e.g., a laptop or other computing device of the user 102), remote devices (e.g., “cloud-based” processing and/or storage), and the like.

Other types of conferencing devices and/or organizations are contemplated. In some embodiments, the conferencing device may be a “thin” device, in that it may serve primarily as an output device for the system 100. For example, an analog telephone may still serve as a conferencing device, with the system 100 presenting speaker or history information via the earpiece of the telephone. As another example, a conferencing device may be or be part of a desktop computer, PDA, tablet computer, or the like.

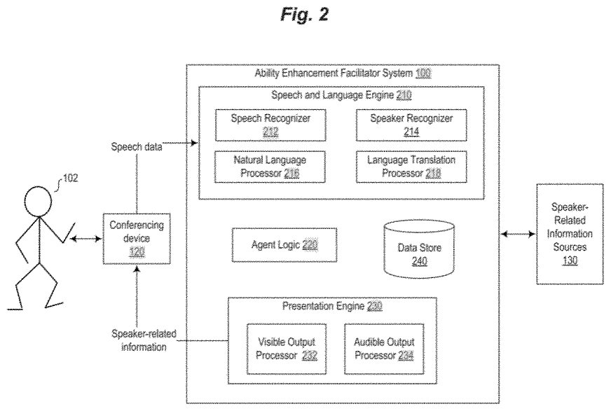

FIG. 2 is an example functional block diagram of an example ability enhancement facilitator system according to an example embodiment. In the illustrated embodiment of FIG. 2, the system 100 includes a speech and language engine 210, agent logic 220, a presentation engine 230, and a data store 240.

The speech and language engine 210 includes a speech recognizer 212, a speaker recognizer 214, a natural language processor 216, and a language translation processor 218. The speech recognizer 212 transforms speech audio data received (e.g., from the conferencing device 120) into textual representation of an utterance represented by the speech audio data. In some embodiments, the performance of the speech recognizer 212 may be improved or augmented by use of a language model (e.g., representing likelihoods of transitions between words, such as based on n-grams) or speech model (e.g., representing acoustic properties of a speaker's voice) that is tailored to or based on an identified speaker. For example, once a speaker has been identified, the speech recognizer 212 may use a language model that was previously generated based on a corpus of communications and other information items authored by the identified speaker. A speaker-specific language model may be generated based on a corpus of documents and/or messages authored by a speaker. Speaker-specific speech models may be used to account for accents or channel properties (e.g., due to environmental factors or communication equipment) that are specific to a particular speaker, and may be generated based on a corpus of recorded speech from the speaker. In some embodiments, multiple speech recognizers are present, each one configured to recognize speech in a different language.

The speaker recognizer 214 identifies the speaker based on acoustic properties of the speaker's voice, as reflected by the speech data received from the conferencing device 120. The speaker recognizer 214 may compare a speaker voice print to previously generated and recorded voice prints stored in the data store 240 in order to find a best or likely match. Voice prints or other signal properties may be determined with reference to voice mail messages, voice chat data, or some other corpus of speech data.

The natural language processor 216 processes text generated by the speech recognizer 212 and/or located in information items obtained from the speaker-related information sources 130. In doing so, the natural language processor 216 may identify relationships, events, or entities (e.g., people, places, things) that may facilitate speaker identification, language translation, and/or other functions of the system 100. For example, the natural language processor 216 may process status updates posted by the user 102a on a social networking service, to determine that the user 102a recently attended a conference in a particular city, and this fact may be used to identify a speaker and/or determine other speaker-related information, which may in turn be used for language translation or other functions.

In some embodiments, the natural language processor 216 may determine topics or subjects discussed during the course of a conference call or other conversation. Information/text processing techniques or metrics may be used to identify key terms or concepts from text obtained from a user utterances. For example, the natural language processor 216 may generate a term vector that associates text terms with frequency information including absolute counts, term frequency-inverse document frequency scores, or the like. The frequency information can then be used to identify important terms or concepts in the user's speech, such as by selecting those having a high score (e.g., above a certain threshold). Other text processing and/or machine learning techniques may be used to classify or otherwise determine concepts related to user utterances, including Bayesian classification, clustering, decision trees, and the like.

The language translation processor 218 translates from one language to another, for example, by converting text in a first language to text in a second language. The text input to the language translation processor 218 may be obtained from, for example, the speech recognizer 212 and/or the natural language processor 216. The language translation processor 218 may use speaker-related information to improve or adapt its performance. For example, the language translation processor 218 may use a lexicon or vocabulary that is tailored to the speaker, such as may be based on the speaker's country/region of origin, the speaker's social class, the speaker's profession, or the like.

The agent logic 220 implements the core intelligence of the system 100. The agent logic 220 may include a reasoning engine (e.g., a rules engine, decision trees, Bayesian inference engine) that combines information from multiple sources to identify speakers, determine speaker-related information, generate voice conference history information, and the like. For example, the agent logic 220 may combine spoken text from the speech recognizer 212, a set of potentially matching (candidate) speakers from the speaker recognizer 214, and information items from the information sources 130, in order to determine a most likely identity of the current speaker. As another example, the agent logic 220 may be configured to search or otherwise analyze conference history information to identify recurring topics, information items, or the like. As a further example, the agent logic 220 may identify the language spoken by the speaker by analyzing the output of multiple speech recognizers that are each configured to recognize speech in a different language, to identify the language of the speech recognizer that returns the highest confidence result as the spoken language.

The presentation engine 230 includes a visible output processor 232 and an audible output processor 234. The visible output processer 232 may prepare, format, and/or cause information to be displayed on a display device, such as a display of the conferencing device 120 or some other display (e.g., a desktop or laptop display in proximity to the user 102a). The agent logic 220 may use or invoke the visible output processor 232 to prepare and display information, such as by formatting or otherwise modifying a transcription, translation, or some speaker-related information to fit on a particular type or size of display. The audible output processor 234 may include or use other components for generating audible output, such as tones, sounds, voices, or the like. In some embodiments, the agent logic 220 may use or invoke the audible output processor 234 in order to convert a textual message (e.g., including or referencing speaker-related information) into audio output suitable for presentation via the conferencing device 120, for example by employing a text-to-speech processor.

Note that although speaker identification and/or determining speaker-related information is herein sometimes described as including the positive identification of a single speaker, it may instead or also include determining likelihoods that each of one or more persons is the current speaker. For example, the speaker recognizer 214 may provide to the agent logic 220 indications of multiple candidate speakers, each having a corresponding likelihood or confidence level. The agent logic 220 may then select the most likely candidate based on the likelihoods alone or in combination with other information, such as that provided by the speech recognizer 212, natural language processor 216, speaker-related information sources 130, or the like. In some cases, such as when there are a small number of reasonably likely candidate speakers, the agent logic 220 may inform the user 102a of the identities all of the candidate speakers (as opposed to a single speaker) candidate speaker, as such information may be sufficient to trigger the user's recall and enable the user to make a selection that informs the agent logic 220 of the speaker's identity.

Note that in some embodiments, one or more of the illustrated components, or components of different types, may be included or excluded. For example, in one embodiment, the system 100 does not include the language translation processor 218.

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the system 100, such as in the data store 420 (or 240), can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 420 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the system 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of this disclosure. For example, the methods, techniques, and systems for ability enhancement are applicable to other architectures or in other settings. For example, instead of providing assistance to users who are engaged in a voice conference, at least some of the techniques may be employed to transcribe and/or analyze media items, events, or presentations, including newscasts, films, programs, or other media items distributed via television, radio, the Internet, or similar mechanisms. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

What is claimed is:

1. A system for facilitating a comprehensive virtual or real-time meeting with accurate real-time translation comprising:
(a) central server over the cloud computing infrastructure;
(b) meeting Software hosted on cloud in the central server;
(c) translation engine hooked up to the meeting software;
(d) speech to text and text to speech conversion engine.

2. A system as claimed in claim 1 wherein, a host sets up the meetings and sends meeting invitations to all participants.

3. A system as claimed in claim 1 wherein, the participants can join the meeting in a meeting room set up or remotely by logging in to the system with their unique ID

4. A system as claimed in claim 1 wherein, each user will set up their native language.

5. A system as claimed in claim 1 wherein, each participant will have his or her monitor (laptop, tablets etc.), mic and headphone or ear piece.

6. A system as claimed in claim 1 wherein, the participants of the meeting will speak in their assigned mic and listen in their assigned headphone.

7. A system as claimed in claim 1 wherein, when someone speaks in the mic software will capture the speech and speech then will be converted to text.

8. A system as claimed in claim 1 wherein, converted text will then be translated for all participants in their native language.

9. A system as claimed in claim 1 wherein, all the participants will see the translated text on their individual screen and participants will have option to see the original text.

10. A system as claimed in claim 1 wherein, the translated text then will converted to speech in user's native language and every user will be able to hear the translated text in their earphone.

11. A system as claimed in claim 1 wherein, a speaker icon will shown next to the translated text and participants can press the speaker icon to listed to the speech.

12. A system as claimed in claim 1 wherein, participants can identify their desire to speak by using the raise hand feature.

13. A system as claimed in claim 1 wherein, a participant can leave the meeting in the middle and rejoin the meeting if meeting has not been finished.

14. A system as claimed in claim 1 wherein, the participants can also turn on video.

15. A system as claimed in claim 1 wherein, the participants can give a presentation for all participants.
